(19) United States
(12) Patent Application Publication
(10) Pub. No.: US 2007/0273617 A1
(43) Pub. Date: Nov. 29, 2007

(54) Field emission display and method for controlling the same

(76) Inventor: Hiroyuki Yamakawa, Ibaraki (JP)

Correspondence Address: Floyd B. Carothers;Carothers and Carothers, 445 Fort Pitt Boulevard, Suite 500, Pittsburgh, PA, 15219, US

(21) Appl. No.: 11/587,474

(22) PCT Filed: Apr. 11, 2005
(86) PCT No.: PCT/JP05/07008

§ 371 Date: Oct. 25, 2006

(30) Foreign Application Priority Data
Apr. 28, 2004 (JP) 2004-132589

(51) Int. Cl. G09G 3/20; G09G 3/22

(52) U.S. Cl. 345/75.2

(57) ABSTRACT

A field emission device and a method for controlling the same which can control a drive voltage so as to place a density of electrons reaching an anode electrode or an anode current into a desired value. A field emission display is provided with a gate electrode 3, an emitter 2, between which and the gate electrode is applied a drive voltage to emit electrons, an anode electrode 5 having a phosphor 6 receiving electrons emitting from the emitter to emit light, a current detector 11 for detecting an anode current flowing through the anode electrode and a drive voltage control 12 for controlling the drive voltage applied between the gate electrode and the emitter on the basis of the anode current detected by the current detector.

### TECHNICAL FIELD

This invention relates to a field emission display (FED: Field Emission Display) and a method for controlling the same and particularly to a field emission display and a method for controlling the same which controls variation of luminance due to variation of density of electrons reaching an anode electrode from an emitter.

### BACKGROUND OF THE TECHNIQUE

A field emission display is the display of the type emitting spontaneous light in which accelerated electrons collide onto phosphors. The light emitting principle of the field emission display is equal to that of the CRT (Cathode Ray Tube). They have similar brightness, wide view angle and responsiveness, and so they are suitable to animation display. However the field emission display does not include a deflecting portion in contrast to the CRT and so it can be flat and light.

A field emission display includes two insulating substrates facing to each other, and spaced apart, for example, 200 μm to about 1 mm. Plural linear cathode electrodes and plural linear gate electrodes intersecting at right angles with each other are formed on one of the two insulating substrates, in matrix form.

FIG. 8 shows a cross sectional view of an intersection of the cathode electrodes 1 and the gate electrodes 3. An insulating layer 4 is interposed between the cathode electrodes 1 and the gate electrodes 3. Holes are formed in the insulations layer 4 on the intersections of the cathode electrodes 1 and the gate electrodes 3. Emitters 2 are formed in the holes and connected electrically to the cathode electrodes 1. The emitter 2 is made of silicon or molybdenum and is formed in a cone. In some cases, the emitter 2 is made of carbon films or carbon nanotubes.

An opening 7 is made penetrating the gate electrode 3 in the thickness direction. The tip of the emitter 2 is facing to the opening 7.

The other insulating substrate is a transparent substrate, for example, made of glass plate. Anode electrode 5 made of transparent material such as ITO (Indium Tin Oxide) is formed on the other insulating substrate. The phosphor 6 is formed on the anode electrode 5, facing to the opening 7, which is facing to the emitter 2.

A drive voltage is applied between the gate electrode 3 and the cathode electrode 1. A positive voltage is applied to the gate electrode 3 and a negative voltage is applied to the cathode electrode 1. A strong electric field concentrates on the tip of the emitter 2. In the emitter 2, electrons surmount the barrier of the work function by the tunnel effect. Electrons are emitted from the emitter 2 and moved towards the anode electrode 5 and pass through the opening 7 and collide on the phosphor 6 to emit light. Thus, picture or video is displayed.

The emitter 2 is arranged in all intersections of the cathode electrode 1 and the gate electrode 3. However, in some FEDs, plural emitters are arranged in all intersections of the cathode electrode 1 and the gate electrode 3. In accordance with variation of shapes and density of emitters, magnitudes of the opening 7 and of the distance between the opening 7 and emitter 2, the density of electrons reaching the anode electrode 5 from the emitter 2 or anode current flowing through the anode electrode 5 varies even at the constant drive voltage applied between the gate electrode 3 and the cathode electrode 1. In a large sized FED, it is difficult to make the electron emission characteristic of each emitter 2 the same on the whole surface of the display.

FIG. 9 shows the relationship between the drive voltage applied to the emitter 2 and the gate electrode 3, and the anode current flowing through the anode electrode 5, in the FED. VO is the voltage at which the emitter starts to emit electrons. For example, emitters a, b and c have different electron emitting characteristics. Anode currents are different at the same voltage. The density of electrons reaching the anode electrode 5 is correlative to the emitting luminance of the phosphor 6. With variation of the anode current, picture and video are irregularly displayed in luminance. Luminance among R (Red), G (Green) and B (Blue) are unbalanced. There are irregular color and color shading in the display.

For example, the patent literature 1 discloses the field emission display in which the current flowing through the cathode electrode is so controlled at the constant gate voltage, as to control the field emitting current between the anode electrode 5, and the cathode electrode 1. In that case, the cathode current is so controlled as to obtain a desired luminance.

Patent Document 1: JP8-273560A

### DISCLOSURE OF INVENTION

### Problem to be Solved by the Invention

Luminance variations depend not only on the electron-emitting characteristics of the emitter itself, but also on the reaching rate to the anode electrode of electrons emitted from the emitter. All of the electrons emitted from the emitter do not always reach the anode electrode 5, but on the way partly flow into the gate electrodes 3. For example, the reaching rate of the electrons to the anode electrode is 50 to 80%. It varies in emitters of the same material and of the same construction.

Luminance of the phosphor is determined by the density of the reaching electrons or the anode current flowing through the anode electrode. The cathode current flowing through the cathode electrode is not only due to the density of the electrons reaching the anode electrode. A portion of the electrons emitting from the emitter is flowing into the gate electrode 3. Although the current flowing through the cathode electrode is controlled in the patent literature 1, the control method of the patent literature 1 cannot accurately control the phosphor to a desired luminance. The phosphor cannot emit light at a desired luminance.

This invention has been made in consideration of the above mentioned problem. The object of the invention is to provide an FED and a method for controlling the same in which a drive voltage can be so controlled as to make an anode current flow or the density of electrons reaching the anode electrode at a desired strength.

### Means for Solving Problem

The FED of the invention is characterized in that it is provided by: a gate electrode; between an emitter and the gate electrode, a drive voltage is applied to emit electrons; an anode electrode is provided having phosphor receiving electrons emitting from the emitter to emit light; a current detector for detecting an anode current flowing through the anode electrode; and a drive voltage control for controlling the drive voltage applied between the gate electrode and the emitter on the basis of the anode current detected by the current detector.

A method for controlling the FED is characterized by: a step of applying a driving voltage between a gate electrode and an emitter to emit light; a step of detecting an anode current flowing through an anode electrode having phosphor receiving electrons to emit light; and a step of controlling a drive voltage applied between the gate electrode and the emitter on the basis of the detected anode current.

In this invention, the anode current is detected. It represents the density of electrons reaching the anode electrode. The drive voltage is so controlled that the anode current becomes predetermined. Variation of electrons reaching the anode electrode is suppressed. The drive voltage is controlled so as to obtain a desired luminance.

### EFFECT OF THE INVENTION

Anode current caused by electrons reaching the anode electrode is fed back to the drive voltage control so as to obtain a predetermined reaching density of electrons. Luminance of the phosphor can be so controlled as to be accurately predetermined. The luminance of the phosphor can be controlled so as to become a desired luminance. The displayed picture or video has regular coloring and is regularly bright.

### BRIEF DESCRIPTION OF THE DRAWINGS

FIG. 1 is a circuit diagram of a control circuit of a field emission display according to a first embodiment of the invention.

FIG. 2 is a circuit diagram of a control circuit for a field emission display according to a second embodiment of the invention.

FIG. 3 is a circuit diagram of the details of a variable register in FIG. 1 and FIG. 2.

FIG. 4 is a schematic perspective view of the field emission display according to the first embodiment of the invention.

FIG. 5 is a cross-sectional view of the field emission display according to the first embodiment of the invention.

FIG. 6 is a schematic perspective view of the field emission display according to the second embodiment of the invention.

FIG. 7 is a cross-sectional view of the field emission display according to the second embodiment of the invention.

FIG. 8 is a schematic view for explaining operations of the FED.

FIG. 9 is a graph showing the relationship between gate electrode-emitter voltage and anode current in the FED.

### EXPLANATIONS OF LETTERS OR NUMERALS

1,1-1.1-n cathode electrode

2,2-1.2-n emitter

3,3-1.3-n gate electrode

4 insulating layer

5 anode electrode

6 phosphor

7 opening

8 transparent substrate

9,9-1.9-n anode electrode

11,11-1.11-n current detector

12,12-1.12-n drive voltage control

13,13-1.13-n variable resistor

14 video data output circuit

### BEST EMBODIMENT OF INVENTION

Next, embodiments of this invention will be described with reference to the drawings.

### First Embodiment

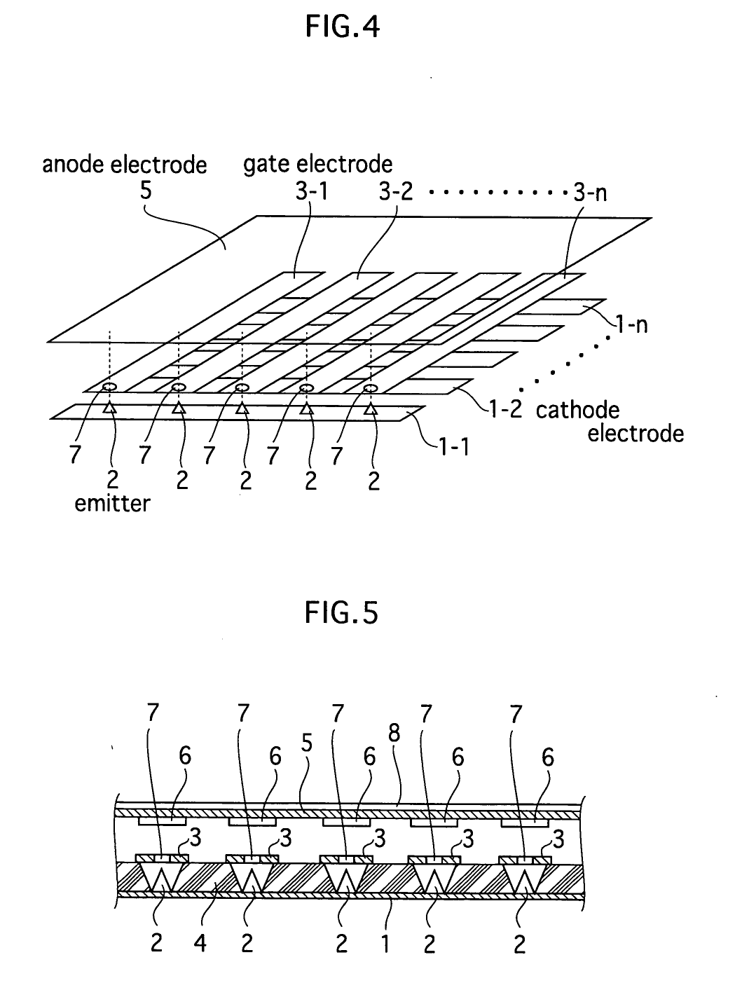

FIG. 4 is a schematic view of an FED according to an embodiment of this invention and FIG. 5 is a cross-sectional view of the FED.

The FED includes two insulating substrates facing to each other, and spaced from each other, for example, by 200 microns to 1 mm, in a vacuum.

Plural linear cathode electrodes 1-1 to 1-n, which are designated by reference numeral 1 representatively in FIG. 5, are formed on the one substrate. An insulating layer 4 is formed on the cathode electrodes 1-1 to 1-n, and plural linear gate electrodes 3-1 to 3-n, which are denoted by reference numeral 3 representatively in FIG. 5, are formed on the insulating layers 4. The cathode electrodes 1-1 to 1-n are perpendicular to the gate electrodes 3-1 to 3-n to form a matrix. The number of the cathode electrodes may not be equal to the number of the gate electrodes.

Holes are formed in the insulating layer 4 on the intersections of the cathode electrodes 1-1 to 1-n and gate electrodes 3-1 to 3-n. The intersections correspond to pixels. Emitters 2 are arranged in the holes and are electrically connected to the cathode electrodes 1-1 to 1-n. The emitters are cone-shaped and made of silicon or molybdenum, or they may be carbon films or carbon nanotubes. One or plural emitters are used for one pixel.

Openings 7 are formed in the gate electrodes 3-1 to 3-n, facing to tips of the emitters 2.

The other substrate is made of transparent glass. An anode electrode 5 is formed on the transparent substrate, facing to the gate electrodes 3-1 to 3-n and the emitters 2. It is a transparent electrode such as ITO (Indium Tin Oxide). In this embodiment, the anode electrode 5 is a single layer which is common to all of the emitters 2.

Phosphors 6 are formed on the anode electrode 5, facing to the opening 7, to which the tip of the emitter 2 faces.

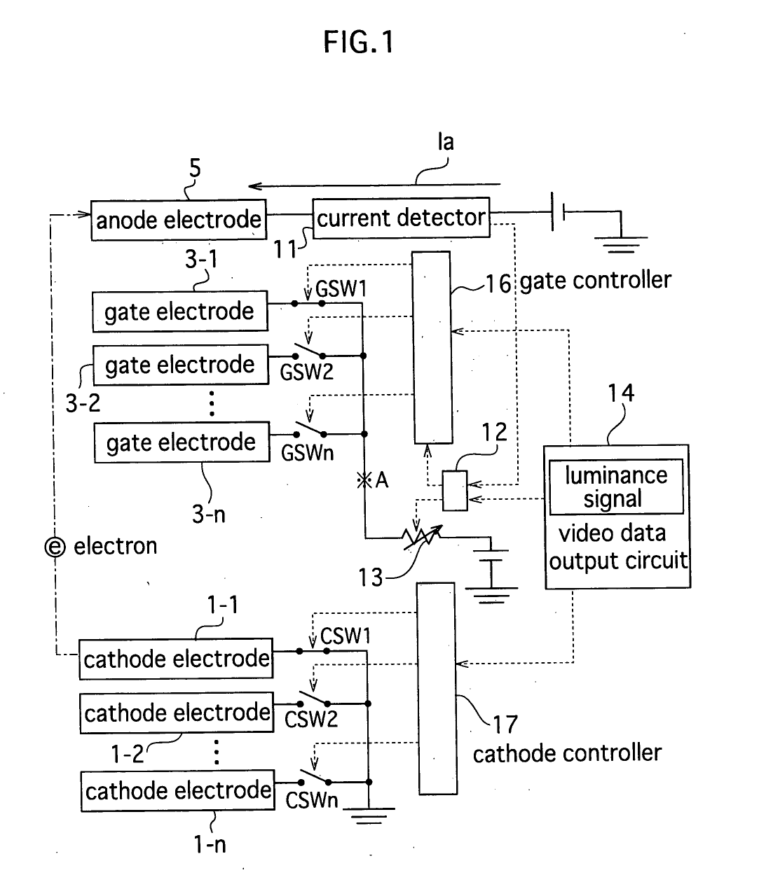

FIG. 1 is a circuit diagram of a circuit of an FED according to an embodiment of this invention. The FED includes a current detector 11, a drive voltage control part 12, a gate controller 16, a cathode controller 17 and a video data output circuit 14 in addition to the above mentioned parts.

A current detector 11 is connected between the anode electrode 5 and a positive power source for applying a positive voltage to the anode electrode 5. Anode current Ia flows through the anode electrode 5 receiving electrons from the emitter 2 and it is detected by the current detector 11 which may be arranged between the power source and the earth.

Switches GSW1 to GSWn are connected between the gate electrodes 3-1 to 3-n and the positive power source for applying a voltage to the gate electrodes 3-1 to 3-n. A variable resistor 13 is connected between the switches GSW1 to GSWn and the power source.

The gate controller 16 turns on and turns off the switches GSW1 to GSWn on the basis of the signal of the video data output circuit 14.

The drive voltage control 12 receives an anode current Ia detected by the current detector 11. Further it receives a luminance signal of a video to be displayed, from the video data output circuit 14. With the luminance signal and the anode current Ia, the drive voltage control 12 controls resistance of the variable resister 13 and directly controls a voltage at a point A in FIG. 1. It turns on, and turns off switches GSW1 to GSWn through the gate controller 16. It may on/off directly control the switches GSW1 to GSWn, not through the gate controller 16.

The cathode controller 17 turns on and turns off switches CSW1 to CSWn connected between the cathode electrodes 1-1 to 1-n and the earth ground on the basis of the signals from the video data output circuit 14.

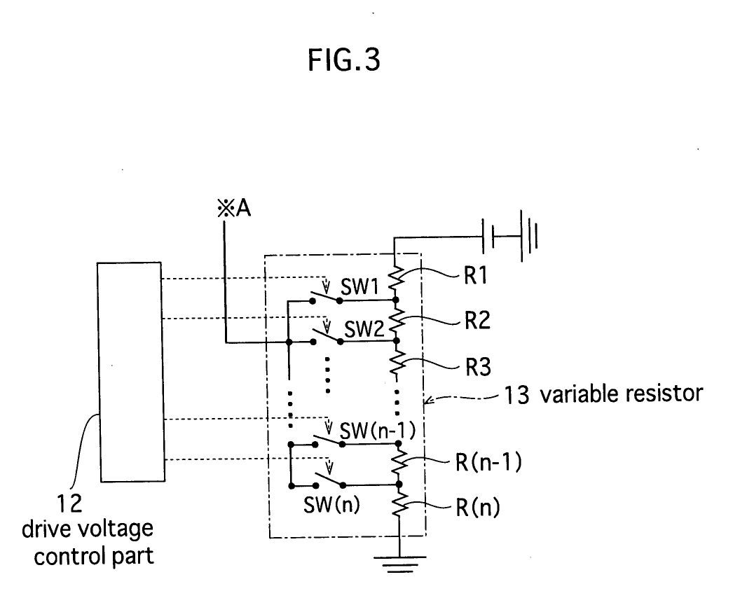

FIG. 3 shows a detailed construction example of the variable resister 13. ※ A represents the connecting point between the circuit of FIG. 1 and FIG. 3.

Variable resistor 13 consists of plural resistors R1 to R(n) serially connected to each other between the power source applying the positive voltage to the gate electrodes 3-1 to 3-n and the ground potential, and switches SW1 to SWn are connected between the connecting points of the resistors R1 to R(n) and switches GSW1 to GSWn.

The voltage of the power source is divided by the resistors R1 to R(n) and the divided voltage is applied to the gate electrodes 3-1 to 3-n. Switches SW1 to SW(n) are selectively turned on, on the basis of the control signals from the drive voltage control part 12. Thus, the desired voltage is applied to the gate electrodes 3-1 to 3-n. However, the construction shown in FIG. 3 is one example. Any construction which can vary resistance, may be used for this invention. It is not limited to the construction as shown in FIG. 3. For example, any electrical circuit which includes an operational amplifier or TTL (Transistor-Transistor Logic) may change the voltage at the connection point ※ A.

Switches GSW1 to GSWn, switches CSW1 to CSWn and switches SW1 to SW(n) are MOSFET, and they are turned on and off in accordance with the signals from the gate controller 16, the cathode controller 17 and the drive voltage control 12.

Next, there will be described control method of the FED according to this embodiment.

The gate controller 16 receives the signal from the video data output circuit 14 to select one of the gate electrodes 3-1 to 3-n, for example, the gate electrodes 3-1. The cathode controller 17 receives the signal from the video data output circuit 14 to select one of the cathode electrodes 1-1 to 1-n, for example the cathode electrode 1-1. A drive voltage is applied between the selected gate electrode 3-1 and the selected cathode electrode 1-1. A positive voltage is applied to the gate electrode 3-1 and a negative voltage is applied to the cathode electrode 1-1. Electrons are emitted from the emitter 2 corresponding to the intersection between the selected gate electrode 3-1 and the selected cathode electrode 1-1, to the anode electrode 5 to which the positive voltage is applied. They pass through the opening 7 of the gate electrode 3-1 to collide onto the phosphor 6 on the anode electrode 5. The phosphor 6 emits light. Video or picture is formed on the display. A portion of the electrons is not passing through the opening 7, but flows into the gate electrode 3-1. In this embodiment, every one of the lines of the gate electrodes and of the cathode electrodes are sequentially selected at the same time. Sequentially, the selections are changed over.

The current detector 1 detects anode current Ia flowing through the anode electrode 5, or density of the electrons reaching the anode electrode 5 from the emitter 2. The detecting current is transmitted to the drive voltage control 12. When the drive voltage control 12 is connected between the anode electrode 5 and the power source or to the higher potential side, the detecting current is, in some cases, transmitted from the current detector 11 to the drive voltage control 12 through a photodiode, light fiber, or photo-coupler under the insulating condition.

The drive voltage control 12 controls a drive voltage to be applied between the gate electrodes 3-1 to 3-n and the cathode electrodes 1-1 to 1-n, on the basis of the comparison between the detecting current and luminance signal of the picture transmitted from the video data output circuit 14. In detail, a voltage to be applied to the gate electrode 3-1 to 3-n is so controlled that the anode current becomes equal to a current to obtain a desired luminance, or when the anode current Ia is a pulse-like current, pulse amplitude, pulse width or pulse frequency is so controlled as to obtain a desired luminance.

When the voltage applied to the gate electrodes 3-1 to 3-n is controlled to control the anode current, the variable resistor 13 is controlled. In detail, the switches SW1 to SW(n) are selectively turned on with the signal from the drive voltage control 12 to change resistance of the resistor 13. Thus, the voltage applied to the gate electrodes 3-1 to 3-n is varied.

Alternatively the voltage applied to the gate electrodes 3-1 to 3-n may be pulse-like. In the gradation control of the luminance, one luminance pulse is divided into plural frames. Pulse currents flow. The phosphors 6 emit light plural times, or it turns on and off in short time. A man recognizes this visually as one shot of light. Gradation of luminance can be controlled with the number of the pulses, the width (time) of the pulse and the amplitude of the pulse or with the combination of them. In detail, in the first frame, the relationship between the gate voltage of the pulse with standard width (time) and anode current is measured as data. The combination of the number of the pulses, the width (time) of the pulse and the amplitude of the pulse can be determined with the above data. The resistance of the variable resistor 13 is so determined as to obtain a predetermined anode current for all phosphors. Thus, the gate voltage is determined. The combination of the number of the pulses, the width (time) of the pulse and the amplitude of the pulse can be so determined that the light amount integrated in the plural frames corresponds to the desired luminance, or it may be determined from the light emitting performance of all phosphors without control of the gate voltage or the variable resistor 13. The number of the pulses and the width (time) of the pulse can be controlled with the on/off of switches GSW1 to GSWn. The pulse amplitude can be controlled with the gate voltage or the variable resistor 13.

Multi-gradation luminance control is difficult to be performed only by pulse width modulation or only by pulse amplitude modulation. However, it can be easily performed by a combination of M-gradation pulse width modulation and N-gradation pulse amplitude modulation. For example, M is rendered as 26 and N is rendered as 16. In that case, 256-gradation control can be easily performed. When arbitrary integers are M and N. M-gradation pulse width modulation and N-gradation pulse amplitude modulation are combined to obtain a pulse wave shape including M×N information.

As described above, the anode current caused by electrons reaching the anode electrode 5 is fed back to the drive voltage control 12 so as to obtain a predetermined reaching density of electrons. Luminance of the phosphor 6 can be so controlled as to be accurately predetermined. The luminance of the phosphor 6 can be controlled so as to generate a desired luminance. The displayed picture or video has regular coloring and is regularly bright. Further, accurate gradation control can be effected and a good picture can be obtained.

### Second Embodiment

Next, a second embodiment of this invention will be described with reference to the drawings. Parts which correspond to those in the above drawings, are denoted by the same reference numerals, and the detailed description of which will be omitted.

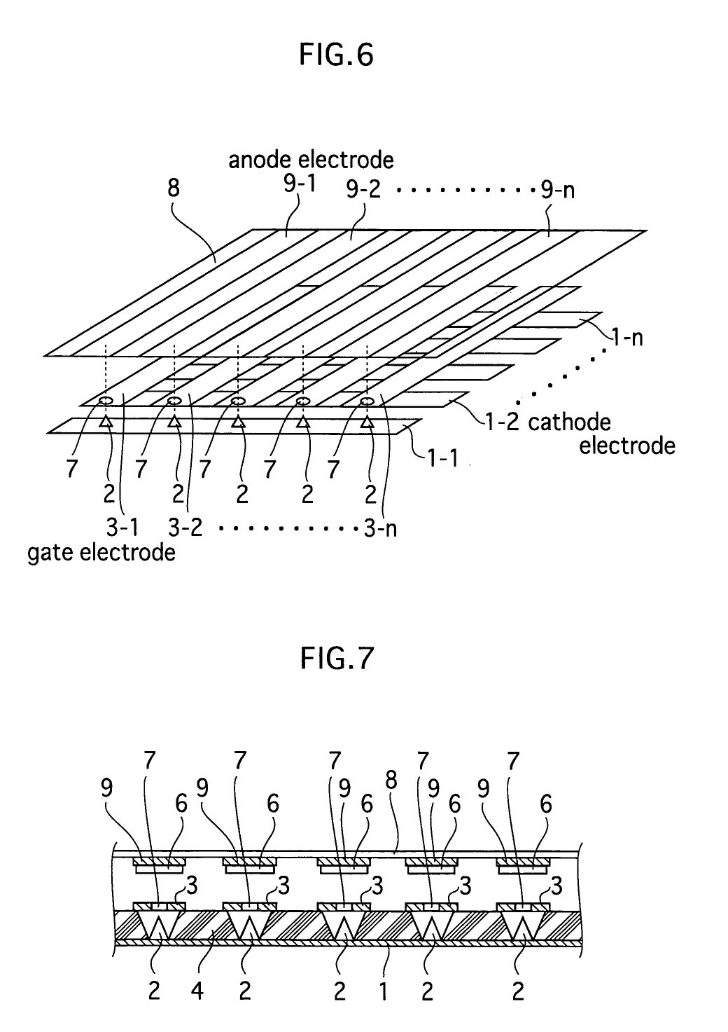

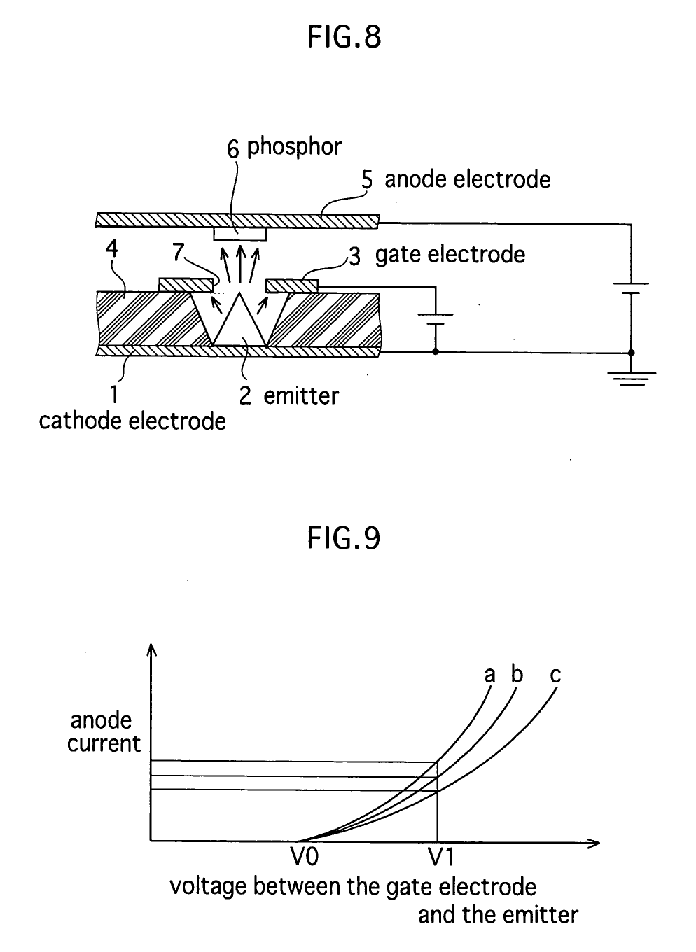

FIG. 6 is a schematic perspective view of an FED according to this embodiment FIG. 7 is a cross-sectional view of the FED. The drive voltage is applied to the selected one of the cathode electrodes 1 and to the gate electrodes 3-1 to 3-n. Electrons are emitted from plural emitters on the selected cathode electrode 1.

Also in this embodiment, the linear cathode electrodes 1-1 to 1-n are intersected with the linear gate electrodes 3-1 to 3-n in matrix.

Holes are made at intersections (pixels) of the cathode electrode 1 and the gate electrodes 3-1 to 3-n in the insulating layer 4. The emitters are arranged in the holes and are electrically connected to cathode electrode 1.

In this embodiment, the anode electrode is divided into plural anode electrodes 9-1 to 9-n which are formed on a transparent substrate 8. The anode electrodes 9-1 to 9-n are transparent electrodes such as ITO (Indium Tin Oxide). The anode electrodes 9-1 to 9-n are parallel to the gate electrodes 3-1 to 3-n and intersect with the cathode electrode 1.

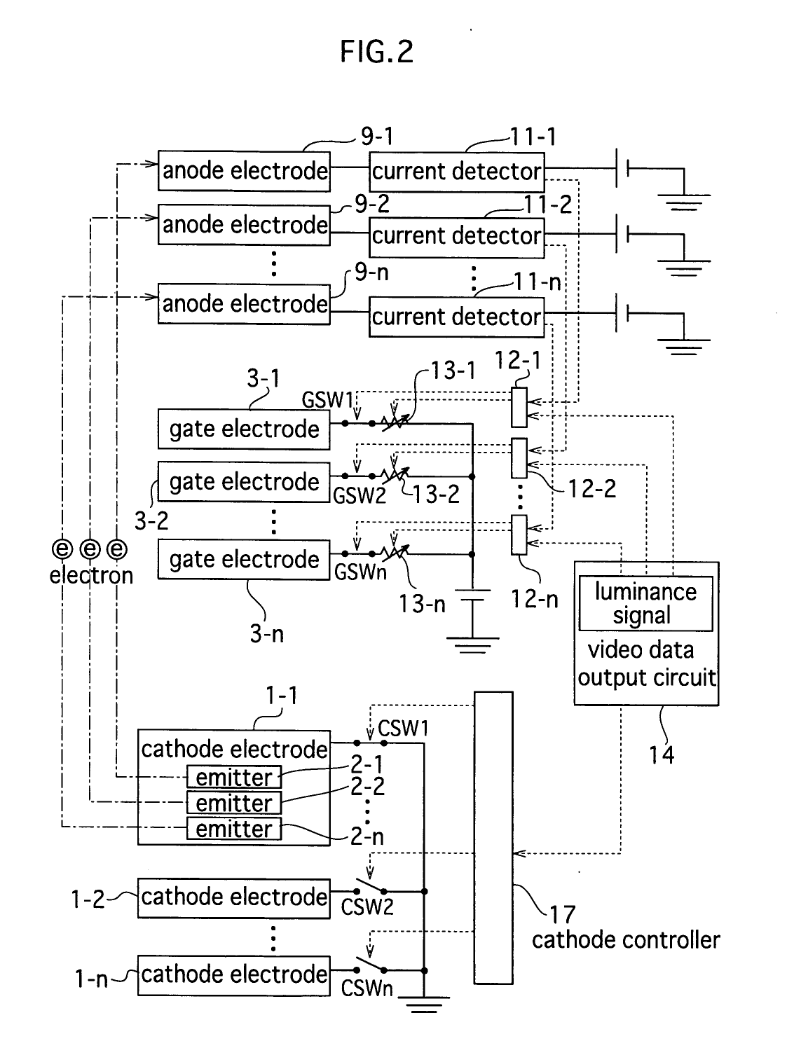

FIG. 2 shows a circuit diagram of an FED according to this embodiment.

Current detectors 11-1 to 11-n are arranged for the divided anode electrodes 9-1 to 9-n, respectively, and are arranged between the anode electrodes 9-1 to 9-n and the power source applying the positive voltage to the anode electrodes 9-1 to 9-n. They detect anode current flowing through the anode electrodes 9-1 to 9-n receiving electrons emitting from the emitters. The power source may be the one which is used in common for the anode electrodes 9-1 to 9-n. However, when the current detector is arranged between the voltage source and the ground, the voltage sources should be arranged individually and independently.

Switches GSW1 to GSWn are connected between the gate electrode 3-1 to 3-n and the positive power source to apply positive potential to the gate electrode 3-1 to 3-n. The variable resistors 13-1 to 13-n are connected between the switches GSW1 to GSWn and the power source and they have the same construction as the variable resistor 13 of the first embodiment.

Plural drive voltage controls 12-1 to 12-n are connected to the plural current detectors 11-1 to 11-n, respectively and they receive the outputs of plural current detecting parts 11-1 to 11-n, representing the anode currents. Further, they receive the outputs of the video data output circuit 14 representing luminance signals to display. The drive voltage controls 12-1 to 12-n control the resistance of the variable resistor 13-1 to 13-n and turn on and off the switches GSW1 to GSWn with the outputs.

The cathode controller 12 turn on and off the switches CSW1 to CSWn connected between the cathode electrode 1 and the ground on the basis of the output signals of the video data output circuit 14.

Next, there will be described the control method of the FED according to this embodiment.

In this embodiment, one of the cathode electrodes, for example, the cathode electrode 1-1, is selected, and plural of the gate electrodes 3-1 to 3-n are selected. Electrons are emitted from the emitters 2-1 to 2-n on the cathode electrode 1-1 at the same time, and they move to the opposed anode electrodes 9-1 to 9-n.

The current detectors 11-1 to 11-n detect anode currents flowing through the anode electrodes 9-1 to 9-n which electrons reach. In accordance with the densities of the reaching electrons, the anode currents flow. Detecting currents are transmitted to the drive voltage control parts 12-1 to 12-n. The current detectors 12-1 to 12-n are connected to the higher potential side, in some cases. The signals are electrically insulated and transmitted to the drive controls 12-1 to 12-n.

The drive voltage controls 12-1 to 12-n control the drive voltage to be applied between the gate electrode 3-1 to 3-n and the cathode electrode 1 on the basis of the comparison between the detecting current transmitted from the plural current detectors 11-1 to 11-n, and the luminance signal transmitted from the video data output circuit 14.

When the anode current is controlled with the voltage applied to the gate electrode 3-1 to 3-n, the variable resistors 13-1 to 13-n are controlled, or when the drive voltage is pulse, resistances of the variable resistors 13-1 to 13-n are at a maintained constant or the amplitudes of the pulse is maintained at constant. With the switch control of switches GSW1 to GSWn, pulse width modulation or pulse frequency modulation may be performed, or as in the first embodiment, the pulse width modulation and the pulse frequency modulation may be combined.

Also in this embodiment, the anode currents flowing through the anode electrodes 9-1 to 9-n or the densities of electrons reaching the anode electrodes 9-1 to 9-n are fed back to the drive controls 12-1 to 12-n. The electrons can reach the anode electrodes 9-1 to 9-n at the desired density. Thus, the drive voltage can be so controlled such that the electrons collide onto the phosphor at the desired density. As the result, the brightness of the phosphor can be controlled to the desired value. The luminance and color are regularly displayed. Further, gradation can be accurately controlled. Clear pictures can be obtained.

While the preferred embodiments of the Invention have been described, without limitation to this, variations thereto will occur to those skilled in the art within the scope of the present inventive concepts that are delineated by the following claims.

The electron collision surface on the anode electrode or fluorescent surface is not always required to be parallel to the cathode electrode, but it may be inclined to the cathode electrode or may be vertical to the cathode electrode. The electrons emitted from the emitter may be curved and collide onto the anode electrode. In that case, the opening need not be formed in the gate electrode.

In the above embodiment, the drive voltage is controlled on the basis of the comparison of the detected anode current and the luminance signal. Instead, a target anode current may be set. The drive voltage control-may control a drive voltage so that the anode current comes to the target anode current.

In the above embodiment, the cathode electrode 1 is connected to ground. The positive voltage applied to the gate electrode 3-1 to 3-n is controlled to control the drive voltage. Instead, with the gate electrode connected to a constant positive potential, a negative voltage applied to the cathode electrode 1 may be controlled so as to control the drive voltage. When the above arrangement is applied to the second embodiment, the extending direction of the cathode electrode 1 is paralleled with the extending direction of the anode electrode 5 and the gate electrodes are intersected with the cathode electrode 1 and anode electrode 5, in some cases. Plural of the cathode electrodes 1 are selected and one of the gate electrode 3-1 to 3-n is selected. Electrons are emitted from the emitter at the same time. Anode current flows through the anode electrode 5 facing to the emitters, and it is detected to control the drive voltage. Further in the above embodiment, the gate voltage applied to the gate electrode 3-1 to 3-n is controlled, while anode current Ia flowing through the anode electrode 5 is detected by the anode current detector 11. Instead, before operation, dummy standard luminance signals are supplied to elements and the relationship between the voltages applied to the gate electrode and the anode current Ia is taken as data, which is memorized in the drive voltage control 12. When an actual luminance signal is received, a necessary voltage may be applied to the gate electrode with reference to the data memorized in the drive voltage control 12.

1. A field emission display comprising:
linear cathode electrodes;
linear gate electrodes arranged above said cathode electrodes and spaced from each other in matrix form;
emitters arranged on said cathode electrodes for emitting electrons with application of a drive voltage between said cathode electrodes and said gate electrodes;
linear anode electrodes corresponding to said gate electrodes and having phosphors to receive electrons emitting from said emitters with application of said drive voltage;
current detectors for detecting anode currents connected to said anode electrodes;
drive voltage controls for controlling said drive voltages on the basis of the anode currents detected by said current detectors; and
a video data output circuit for supplying video data or luminance signals to said drive voltage controls.

2. A field emission display according to claim 1, in which said drive voltage controls receive luminance signal for picture display and control said drive voltage on the basis of comparison of said anode current detected by said current detectors and said luminance signal.

3. A method for controlling a field emission display that it is provided with:
linear cathode electrodes;
linear gate electrodes arranged above said cathode electrodes and spaced from each other in matrix form;
emitters arranged on said cathode electrodes for emitting electrons with application of a drive voltage between said cathode electrodes and said gate electrodes;
linear anode electrodes corresponding to said gate electrodes and having phosphors to receive electrons emitting from said emitters with application of said drive voltage;
current detectors for detecting anode currents connected to said anode electrodes;
drive voltage controls for controlling said drive voltages on the basis of the anode current detected by said current detecting parts; and
a video data output circuit for supplying luminance signals to display to said drive voltage controls, the method comprising:
detecting said anode current, and the luminance data of picture or video to be displayed from said video output circuit, and comparing them with each other within the time of the display of said luminance data, and controlling said drive voltage such that the luminance within said time of display becomes said luminance data.

4. A control method for controlling a field emission display according to claim 3 in which said drive voltage is controlled by changing voltage.

5. A method for controlling a field emission display according to claim 3 in which said drive voltage is pulse-like and of constant amplitude, and is modulated to control said drive voltage.

6. A method for controlling field emission device according to claim 3 in which said drive voltage is applied in the form of a pulse and is controlled with the combination of pulse amplitude modulation and pulse width modulation.

7. A method for controlling field emission device according to claim 3 in which said drive voltage is controlled on the basis of the comparison of the detected anode current and the luminance signal of the picture to be displayed.

8. A method for controlling a field emission display that it is provided with:
linear cathode electrodes;
linear gate electrodes arranged above said cathode electrodes and spaced from each other in matrix form;
emitters arranged on said cathode electrodes, emitting electrons with application of drive voltage between said cathode electrode and said gate electrodes;
linear anode electrodes corresponding to said gate electrodes and having phosphors to receive electrons emitting from said emitters with application of said drive voltage;
current detectors for detecting anode currents connected to said anode electrodes;
drive voltage controls for controlling said drive voltages on the basis of the anode currents detected by said current detectors; and
a video data output circuit for supplying video data or luminance signal to said drive voltage controls, the method comprising:
selecting one of the cathode electrodes;
selecting plural of the gate electrodes and applying drive voltage to the selected electrodes;
emitting electrons from emitters in intersections of the selected cathode electrodes and said plural gate electrodes and emitting light from the phosphors at the same time; and
detecting said anode current having said phosphor emitting light and controlling the drive voltage to said gate electrodes corresponding to said phosphors.
